(19) United States
(12) Patent Application Publication
(10) Pub. No.: US 2010/0227116 A1
(43) Pub. Date: Sep. 9, 2010

(54) THREE-DIMENSIONAL SHEET STRUCTURE, METHOD FOR MAKING SAME, AND SANDWICH-TYPE STRUCTURAL MATERIAL COMPRISING SUCH STRUCTURE

(75) Inventors: Laurent Leylekian, Orsay (FR); Bertrand Laine, Clamart (FR)

Correspondence Address: J. Rodman Steele;Novak Druce & Quigg LLP, 525 Okeechobee Blvd, Suite 1500, West Palm Beach, FL, 33401, US

(73) Assignee: ONERA, Chatillon Cedex (FR)

(21) Appl. No.: 12/682,908

(22) PCT Filed: Oct. 15, 2008
(86) PCT No.: PCT/FR08/01449

§ 371 Date: Apr. 14, 2010

(30) Foreign Application Priority Data
Oct. 17, 2007 (FR) 0707273

(51) Int. Cl. B32B 3/12; E04C 2/32; B32B 38/00; B31F 1/20

(52) U.S. Cl. 428/116; 428/178; 156/211; 156/210

(57) ABSTRACT

The invention relates to a three-dimensional sheet structure characterised in that it comprises at least: a first sheet (1) comprising a plurality of first ribs (3) on one surface thereof; and a second sheet (2) including on one surface thereof a plurality of second ribs (6) intersected by flutes (9) having a shape complementary to that of the first ribs (3) of said first sheet (1); and in that said first and second sheets (1, 2) are superimposed and attached together, each of said first ribs (3) of said first sheet (1) being received in one of said flutes (9) of said second sheet (2).

This invention relates to a geometrically non-developable, three-dimensional sheet structure, a method for making the same and a sandwich-type structural material comprising such structure.

Many sandwich-type structural materials are already known generally as panels, comprising a core provided between two outer skins being integral with opposite faces of said core. The core and said skins of such sandwich-type structural materials are made in a wide variety of constituent materials.

Among such sandwich-type structural materials, the most commonly used in the aeronautical field are those comprising a honeycomb core, that is made with joining hexagonal cells, orthogonal to said outer skins. Depending on applications, the constituent material of said cells can be cardboard, aluminium, aramid fibre/resin composite material, titanium, etc.

Such a honeycomb core is generally obtained through folding and bonding sheets having a natural stiffness or subsequently stiffened by curing an impregnation resin. In any case, however, the honeycomb structure of the core is still basically made of cylindrical cells, resulting in the structure having a smaller compressive strength in a direction orthogonal to generators of said cells.

The object of this invention is to overcome such drawback. For that purpose, according to the invention, the three-dimensional sheet structure is remarkable in that:
it comprises at least:
   a first sheet which comprises, on one side thereof, a plurality of first ribs and which is geometrically developable; and
   a second sheet comprising, on one side thereof, a plurality of second ribs, intersected by channels having a shape complementary to that of said first ribs of said first sheet, said second sheet being geometrically developable;
said channels of said second sheet are formed by alignments of first notches in said second sheet at the level of said second ribs; and
said first and second sheets are superimposed and attached to each other with each of said first ribs of said first sheet entirely and continuously accommodated in one of said channels of said second sheet.

Thus, with this invention, from geometrically developable sheets, in any desired constituent material depending on the application being looked for, a geometrically non-developable, three-dimensional structure can be obtained, with closed cells, the walls of which are formed by a single thickness of the sheets which make up the same, having a high bending and compressive stiffness, as a result of buttressing of said sheets on each other. The structure of the invention additionally has excellent sound attenuation properties, particularly when it is coupled to outer skins, as discussed below.

Because said channels of said second sheet are formed with alignments of notches, it is possible to make, in said second sheet laid flat, openings which, after said second ribs are formed by folding said second sheet, form said notches.

In order to achieve even higher mechanical and sound properties, the three-dimensional structure according to the invention is advantageously such that:
said first sheet comprises, on the side thereof opposite to said first ribs, a plurality of third ribs;
it comprises additionally a third sheet comprising, on one side thereof, a plurality of fourth ribs, intersected by channels having a complementary shape to that of said third ribs of said third sheet, said third sheet being geometrically developable;
said channels of the third sheet are formed by alignments of second notches in said third sheet at the level of said fourth ribs; and
said first and third sheets are superimposed and attached to each other with each of said third ribs of said first sheet entirely and continuously accommodated in one of said channels of said third sheet.

As for said second sheet, said third sheet, having a constituent material similar or different from those of said first and second sheets, can be obtained by flat cutting and folding.

In each of the pluralities of said first, second, third and fourth ribs, the corresponding ribs can be parallel.

In addition, the ribs advantageously have apexes forming longitudinal resting lands between said sheets.

Preferably, said first sheet has a staggered profile. Thus, said first and third ribs are respectively formed by the dihedral angles of said first sheet protruding on either side of the latter.

Said three-dimensional structure according to this invention may be in the form of a flat panel. It may also have a curved (with constant or varying radius) and even cylindrical shape. In both cases, sheets of said structure are preferably made flat, then given the desired curved (or cylindrical) shape and then assembled.

Besides, said second ribs of said second sheet may be orthogonal or oblique in relation to said first ribs of said first sheet. Similarly, said fourth ribs of said third sheet can be orthogonal or oblique in relation to said third ribs of said first sheet.

Said three-dimensional structure according to this invention can readily be used as a core for making a sandwich-type structural material. In this case, at least one outer skin is attached to at least one of the opposite sides of said structure, for example by bonding.

The figures of the appended drawing will make it clearer how the invention can be carried out. In these figures, same references refer to similar elements.

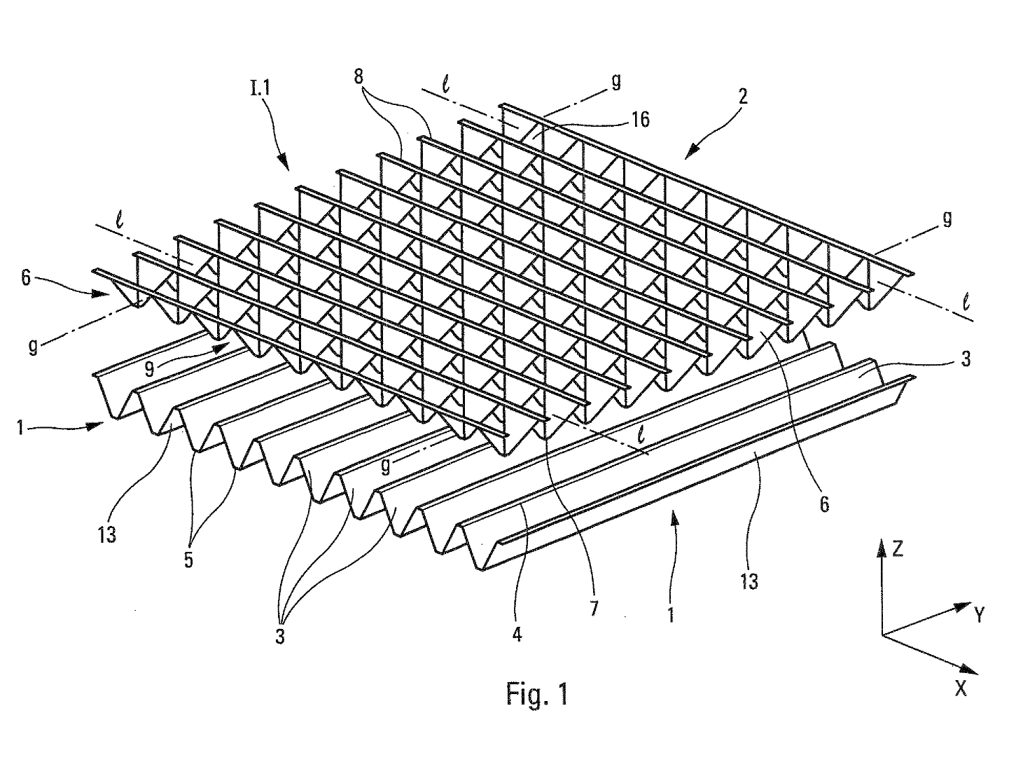

FIG. 1 illustrates, in a partial exploded perspective view, a dual sheet embodiment of the three-dimensional structure according to this invention.

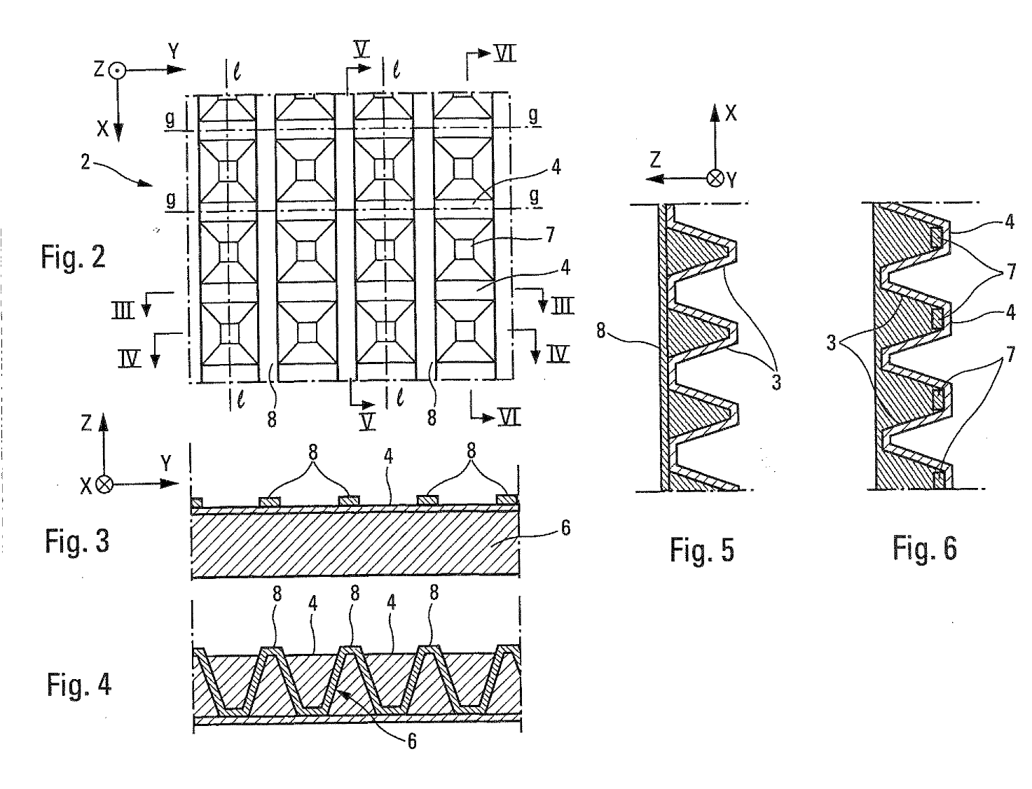

FIG. 2 is a plan view of the structure of FIG. 1, with both constituent sheet of such structure assembled.

FIGS. 3 to 6 are respectively cross-section views along lines IV-IV, V-V and VI-VI in FIG. 2, with the thicknesses of said constituent sheets of the three-dimensional structure being enlarged for the sake of clarity in the drawings.

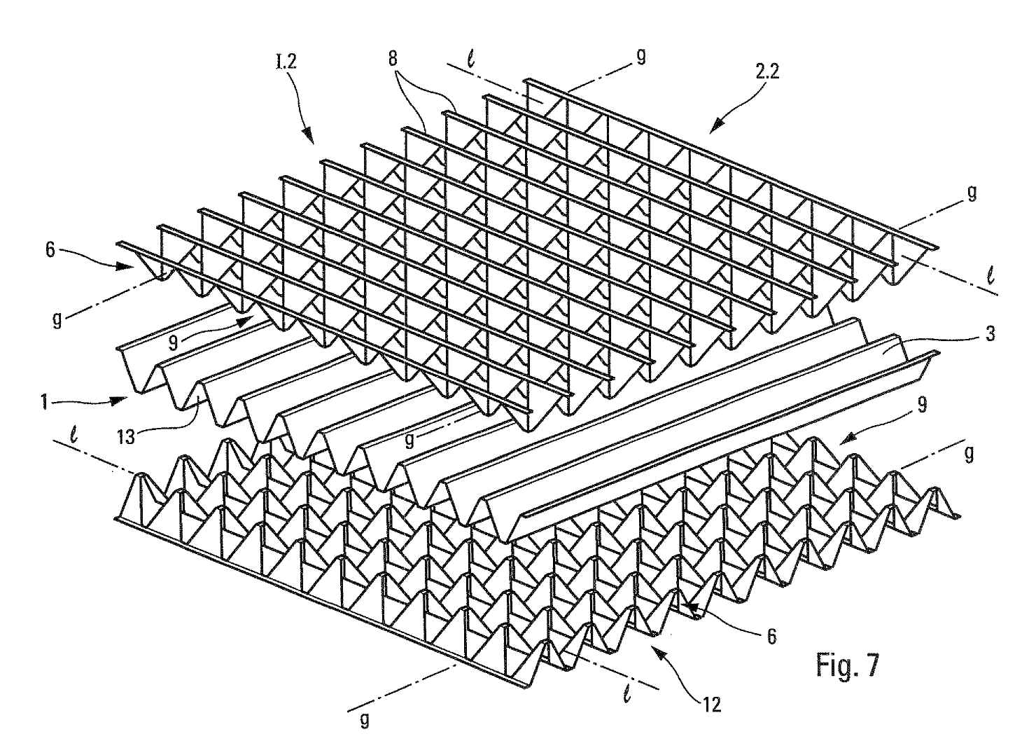

FIG. 7 illustrates, in a partial exploded view, another embodiment of the three-dimensional sheet structure according to this invention.

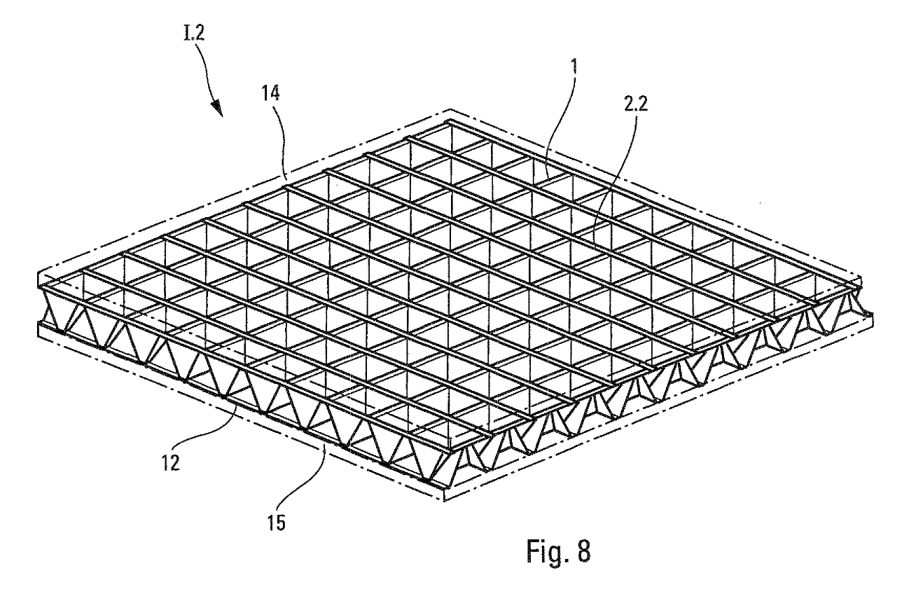

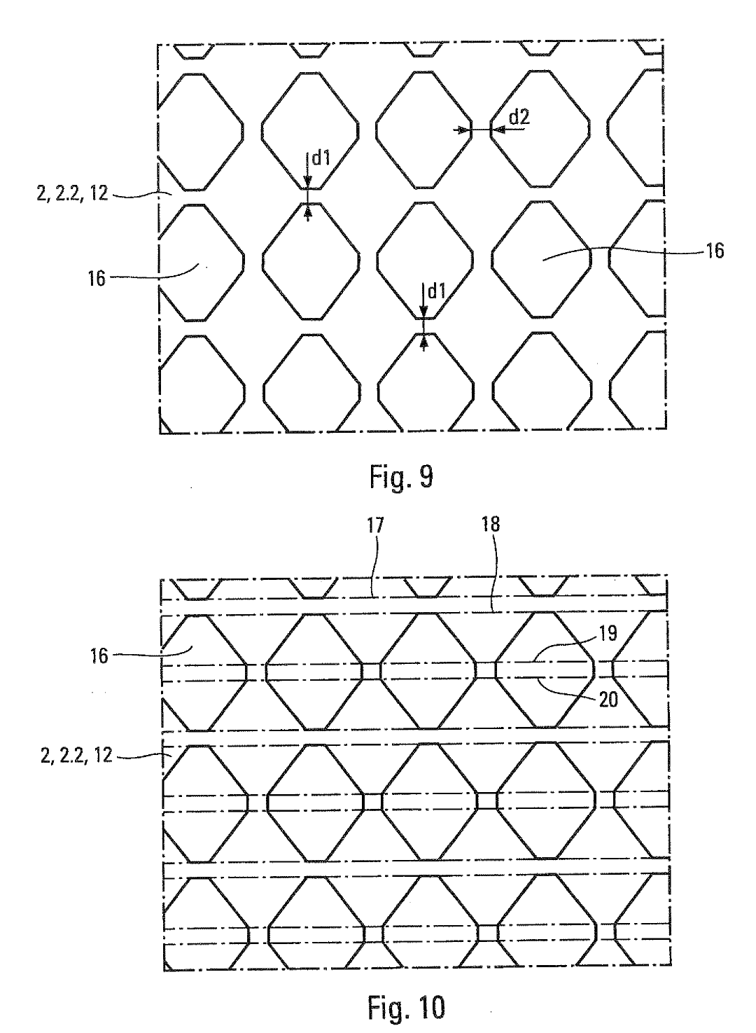

FIG. 8 shows, in a perspective view, the structure of FIG. 7, with different constituent sheets thereof being assembled.

FIGS. 9 and 10 show, in a flat condition, a blank for two constituent sheets of the structures in FIGS. 1 to 6 and 7 and 8.

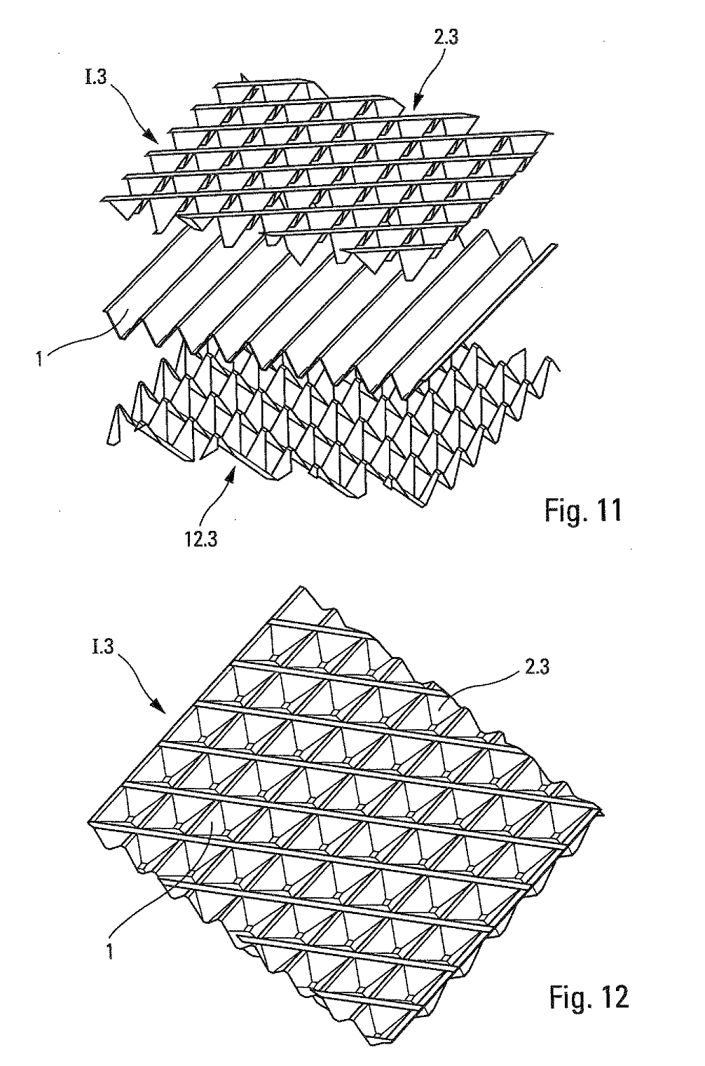

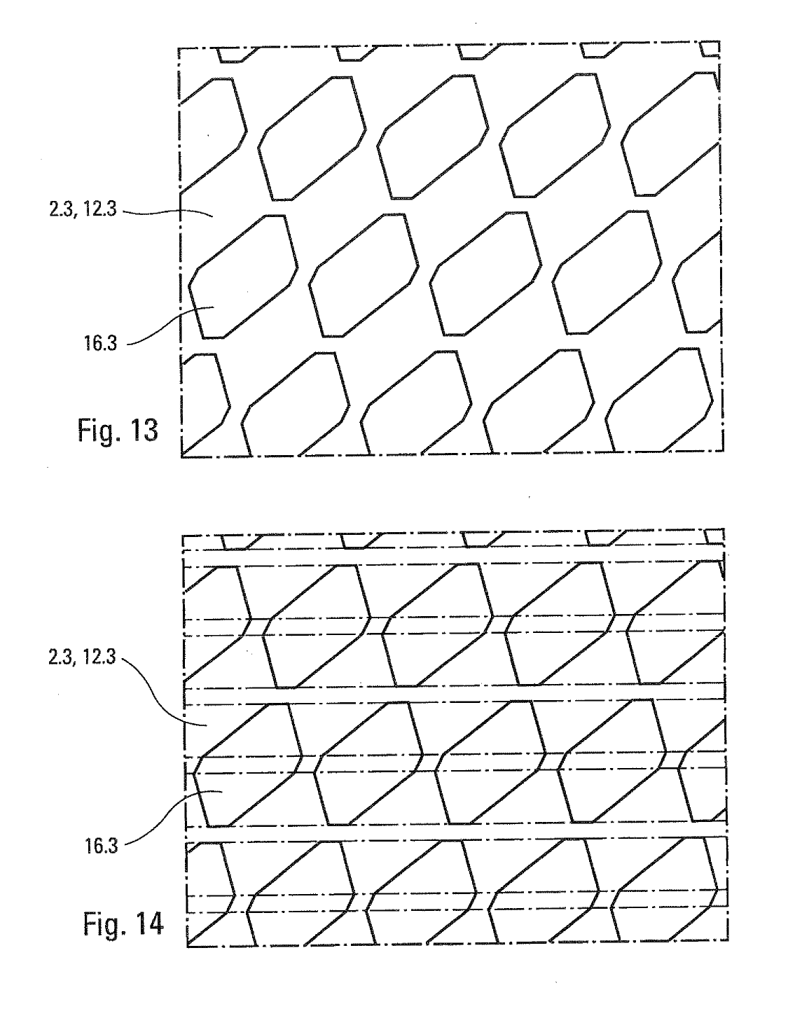

FIGS. 11 and 12 illustrate, in an exploded perspective view and in an assembled position, respectively, yet another embodiment of the three-dimensional sheet structure according to this invention.

FIGS. 13 and 14 show, in a flat condition, a blank for two of the sheets of the structure of FIGS. 11 and 12.

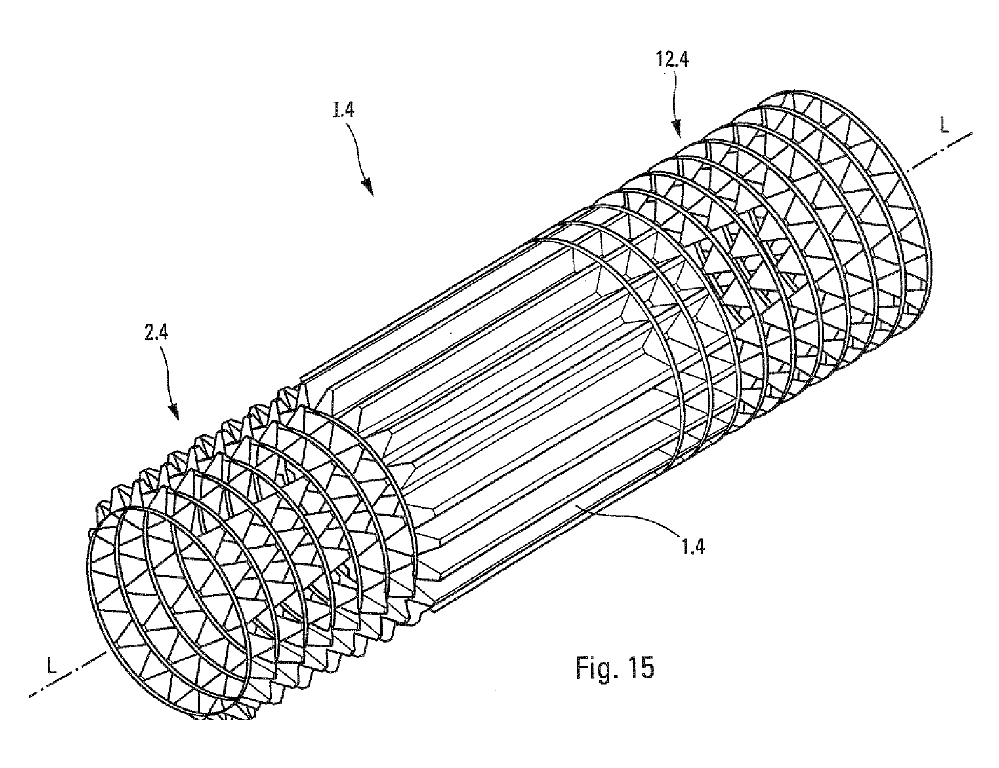

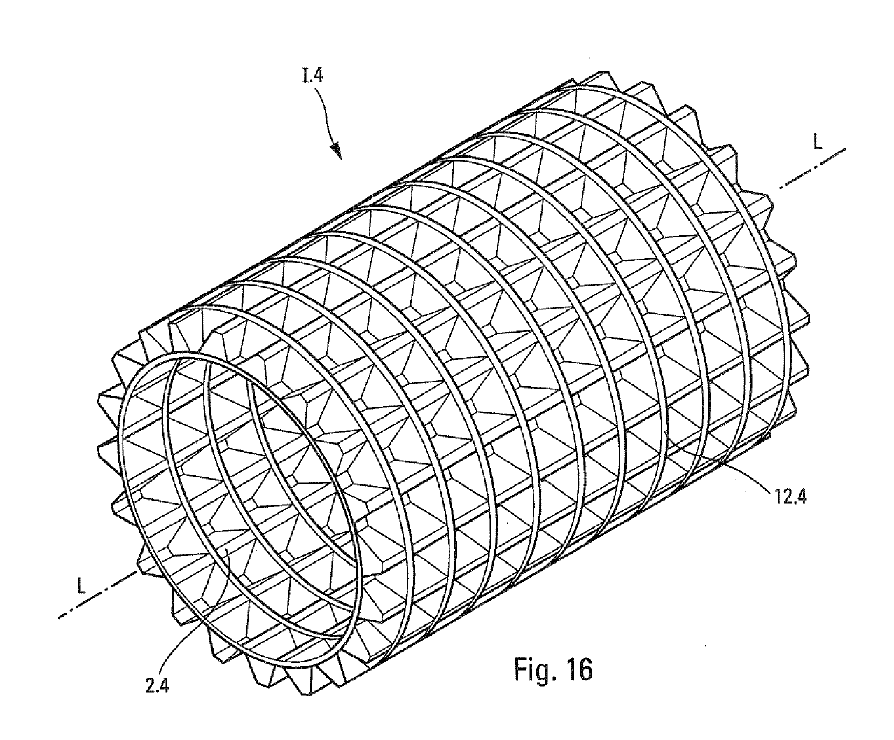

FIGS. 15 and 16 are perspective views showing, in an assembling condition and in an assembled position, respectively, a cylindrical embodiment of the three-dimensional sheet structure according to this invention.

The three-dimensional sheet structure I.1, according to this invention and shown in FIGS. 1 to 6, comprises two sheets 1 and 2.

The first sheet 1 has a staggered profile and comprises a plurality of protruding dihedral angles forming, facing the second sheet 2, first parallel ribs 3. The tips and bottoms of said first ribs 3 are cut to form longitudinal lands 4 and 5, respectively. Because of this staggered profile, on the opposite side of said second sheet 2, the first sheet 1 comprises a plurality of protruding dihedral angles forming parallel ribs 13.

The second sheet 2 also has a staggered profile and comprises a plurality of protruding dihedral angles forming, facing the first sheet 1, second parallel ribs 6, indicated by the axes l-l thereof in FIGS. 1 and 2. In the same way as the first sheet 1, tips of said second ribs 6 are cut by longitudinal lands 8. However, the bottoms of said second ribs 6 are intersected by discontinuous lands 7 which make it possible for the first ribs to be entirely and continuously accommodated in the channels 9 of the second sheet 2.

The second parallel ribs 6 are intersected by channels 9, indicated by the axes g-g thereof in FIGS. 1 and 2, having a shape complementary to that of the first ribs 3 of first sheet 1, said channels 9 of the second sheet 2 being formed by alignments of notches in the second parallel ribs 6.

Thus, as suggested in FIG. 1, said first and second sheets 1 and 2 can be superimposed and attached to each other, for example by bonding, so that each of the first ribs 3 of the first sheet 1 is accommodated in one of the channels 9 of the second sheet 2.

FIG. 2 shows the top view of the structure I.1 of FIG. 1 after being assembled. FIGS. 3 and 6 show different cross-sections in this structure along the lines indicated on FIG. 2. The sheets are shown with such a thickness as to make reading easier by integrating a differentiated pattern therein depending on the relevant sheet. The cross-sections and panels of the sheet 1 are shown with the bold hatching, whereas the cross-sections and panels of the sheet 2 are shown with fine hatching.

The embodiment I.2, respectively shown in an exploded view and in an assembled condition in FIGS. 7 and 8, again features the first sheet 1 described above and the second sheet 2.2, similar to the second sheet 2 of structure I.1. In addition, the three-dimensional structure I.2 comprises a third additional sheet 12, identical to said sheet 2.2, but provided on the opposite side thereof in relation to the first sheet 1. In the same way as the second sheet 2 of the structure I.1, each of said second sheet 2.2 and first sheet 12 of the structure I.2 comprises a plurality of parallel ribs similar to said ribs 6 of the structure I.1 and respectively designated as second and fourth ribs. These ribs of sheets 2.2 and 12 are indicated by the axes l-l thereof on FIG. 7. They are intersected by channels similar to said channels 9, indicated by the axes g-g thereof in the latter figure. As suggested in the figure, the second sheet 2.2 and the third sheet 12 may be superimposed and attached to the first sheet 1, such that each of the first parallel ribs 3 of said first sheet 1 is accommodated in one of the channels of the second sheet 2.2 (in the same way as described for structure I.1) and that each of the third parallel ribs 13 of said first sheet 1 is accommodated in one of the channels of the third sheet 12.

Therefore, the structure I.2 shown on FIG. 8 is obtained.

As shown in the latter figure, the structure I.2 can be covered by outer skins 14 and 15 on both opposite sides thereof. Such outer skins are attached to the structure I.2, for example by bonding, such that said structure I.2 and skins 14 and 15 together form a sandwich-type structural material.

The sheets 2 of structure I.1 and the sheets 2.2 and 12 of structure I.2 have the particular feature that the recesses in the ribs 6 thereof in order to form the channels 9 for respectively accommodating ribs 3 and 13 of sheet 1, are formed by notches provided in said sheets 2, 2.2 and 12 at the level of the ribs 6 thereof.

As illustrated in FIGS. 9 and 10, such notches result:
from cutting out individual openings 16 (for example diamond shaped with cut corners) in the sheets 2, 2.2, 12 laid flat, said openings being arranged in rows (parallel to axes l-l) and in columns (parallel to axes g-g), with two consecutive openings 16 in a column being spaced apart by a distance b1 corresponding to the desired width for the lands 8 and two consecutive openings of a row being spaced apart by a distance d2 corresponding to the desired width for the lands 7 (FIG. 9); and then
from accordion folding of sheets 2, 2.2 and 12 along couples of folding lines 17, 18 and 19, 20, parallel to axes l-l, with the folding lines 17 and 18 passing through the ends facing the openings 16 provided in the adjacent rows and thus being separated by the distance d1, whereas the folding lines 19 and 20, spaced apart by the distance d2, pass through vicinity of the centre of said openings 16 provided in the rows (FIG. 10).

The result of such cutting and such folding of sheets 2, 2.2 and 12 can be seen on FIGS. 1 and 7.

In structures I.1 and 1.2 described above, sheets 2, 2.2 and 12 are shown with channels 9 orthogonal to the ribs 6, such that the ribs 3 and 13 of sheet 1 are themselves orthogonal to said ribs 6, after assembling said sheets. Alternatively, FIGS. 11 and 12 show, in similar views as FIGS. 7 and 8, respectively, a structure I.3 according to this invention wherein sheets 2.3 and 12.3 (respectively corresponding to sheets 2.2 and 12) have oblique channels in relation to their ribs. The result is that in the structure I.3, the ribs 3 and 13 of the sheet 1 are oblique with respect to the ribs of sheets 2.3 and 12.3.

On FIGS. 13 and 14, being respectively comparable to FIGS. 9 and 10, it can be seen that openings 16.3 (comparable to openings 16) are then oblique and the columns they form are tilted with respect to the rows of said openings.

The structure I.4, shown on FIGS. 15 and 16, has a cylindrical shape. It is made of:
a first intermediate sheet 1.4, being comparable to sheet 1 described above, but rolled as a cylinder about an axis L-L parallel to the ribs 3 and 13;
a second inner sheet 2.4, being comparable to sheet 2.2 described above, but rolled as a cylinder about the axis L-L parallel to the channels 9 thereof, in which the ribs 3 of sheet 1.4 are accommodated; and
a third outer sheet 12.4, being comparable to sheet 12 described above, but rolled as a cylinder about the axis L-L parallel to the channels 9 thereof, in which the ribs 13 of sheet 1.4 are accommodated.

As shown on FIG. 15, the sheets 1.4, 2.3 and 12.4 may be assembled one to another by sliding parallel to the axis L-L in order to obtain said cylindrical structure I.4 with the axis L-L.

1. A three-dimensional sheet structure, comprising:
a first sheet (1) which comprises, on one side thereof, a plurality of first ribs (3) and which is geometrically developable; and
a second sheet (2) comprising, on one side thereof, a plurality of second ribs (6), intersected by channels (9) of a shape complementary to that of said first ribs (3) of said first sheet (1), said second sheet (2) being geometrically developable;
said channels (9) of said second sheet (2) are formed by alignments of first recesses (16) in said second sheet at said second ribs (6); and
said first and second sheets (1, 2) are superimposed and attached to each other with each of said first ribs (3) of said first sheet (1) entirely and continuously accommodated in one of said channels (9) of said second sheet (2).

2. The structure according to claim 1, wherein:
said first sheet (1) comprises, on the side thereof opposed to said first ribs, a plurality of third ribs (13);
said structure comprises a third sheet (12) comprising, on one side thereof, a plurality of fourth ribs (6), intersected by channels (9) of a shape complementary to those of said third ribs (13) of said first sheet (1), said third sheet (12) being geometrically developable;
said channels of said third sheet (12) are formed by alignments of second recesses (16) in said third sheet (12) at the level of said fourth ribs (6); and
said first and third sheets (1, 12) are superimposed and attached to each other with one of said third ribs (13) of said first sheet (1) entirely and continuously accommodated in one of said channels (9) of said third sheet (12).

3. The structure according to claim 1, wherein, in at least one of said plurality of ribs, the corresponding ribs are parallel.

4. The structure according to claim 1, wherein, in at least said plurality of ribs, the apexes of the corresponding ribs form longitudinal lands.

5. The structure according to claim 1, wherein said first sheet (1) has a staggered profile.

6. The structure according to claim 1, wherein said sheet structure forms a planar panel.

7. The structure according to claim 1, wherein said sheet structure has a curved shape.

8. The structure according to claim 7, wherein said sheet structure has a cylinder shape (I.4).

9. The structure according to claim 1, wherein said second ribs (6) of said second sheet (2) are orthogonal to said first ribs (3) of said first sheet (1).

10. The structure according to claim 1, wherein said second ribs (6) of said second sheet (2) are oblique with respect to said first ribs (3) of said first sheet (1).

11. The structure according to claim 2, wherein said fourth ribs (6) of said first sheet (12) are orthogonal to said third ribs (13) of said first sheet (1).

12. The structure according to claim 2, wherein said fourth ribs (6) of said third sheet (12) are oblique with respect to said third ribs (13) of said first sheet (1).

13. Sandwich-type structural material, wherein said sandwich-type structural material comprises a core made of a structure according to claim 1 and at least one outer skin (14, 15) attached to at least one of the opposed sides of said structure.

14. (canceled)

15. (canceled)

16. (canceled)

17. A method for making a three-dimensional sheet structure according to claim 1, comprising:
accordion folding a first sheet (1),
cutting out a plurality of first openings in a second sheet that is laid out;
accordion folding said second sheet such that said first openings (16) form said first recesses in the protruding folds provided on a same side of said second sheet (2), and
super imposing and attaching said first and second sheets to each other.

18. The method according to claim 17, further comprising:
cutting out a plurality of second openings in a third sheet that is laid out;
accordion folding said third sheet such that said second openings (16) form said second recesses in the protruding folds provided on a same side of said third sheet (2), and super imposing and attaching said first and third sheets to each other.

19. The method according to claim 17, further comprising:
making flat sheets of said structure;
forming said sheets to the desired curved shape; and
assembling said sheets.
